(19) United States
(12) Patent Application Publication
(10) Pub. No.: US 2014/0355975 A1
(43) Pub. Date: Dec. 4, 2014

(54) CAMERA

(71) Applicant: Ingrasys Technology Inc., Taoyuan 330 (TW)

(72) Inventor: SHU-YUN HUANG, Taoyuan (TW)

(73) Assignee: Ingrasys Technology Inc., Taoyuan 330 (TW)

(21) Appl. No.: 14/288,946

(22) Filed: May 28, 2014

(30) Foreign Application Priority Data
Jun. 4, 2013 (TW) 102119844

(51) Int. Cl. G03B 17/56

(52) U.S. Cl. CPC G03B 17/561
USPC 396/428

(57) ABSTRACT

Camera includes a first bracket, a second bracket, a shield member, a photosensitive element, and a cable. The first bracket includes a base defining a through hole. The second bracket is pivotally connected to the first bracket. The shield member is made of material that shields electromagnetic interference. The shield member is received in the through hole, and defines an inner hole. The photosensitive element is mounted to the second bracket. The cable is electrically connected to the photosensitive element, and extends through the inner hole.

### FIELD

The present disclosure relates to a camera.

### BACKGROUND

In a camera, a photosensitive element is electrically connected to a circuit board by cables.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a camera.

FIG. 2 is an assembled view of FIG. 1, and viewed from another perspective.

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

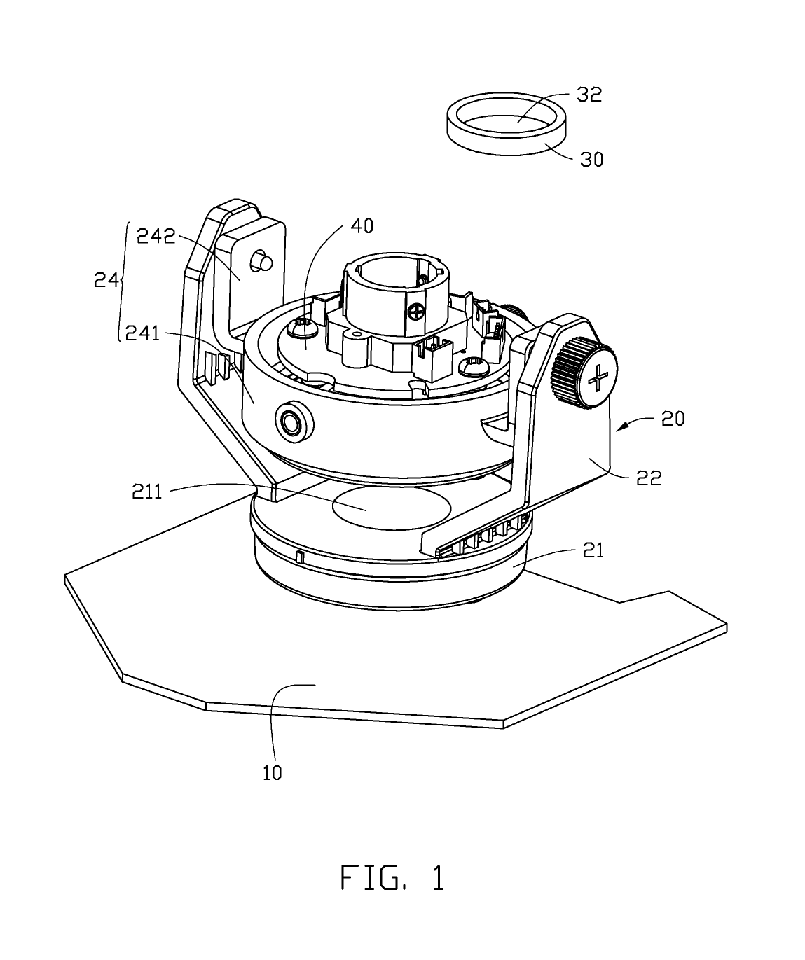

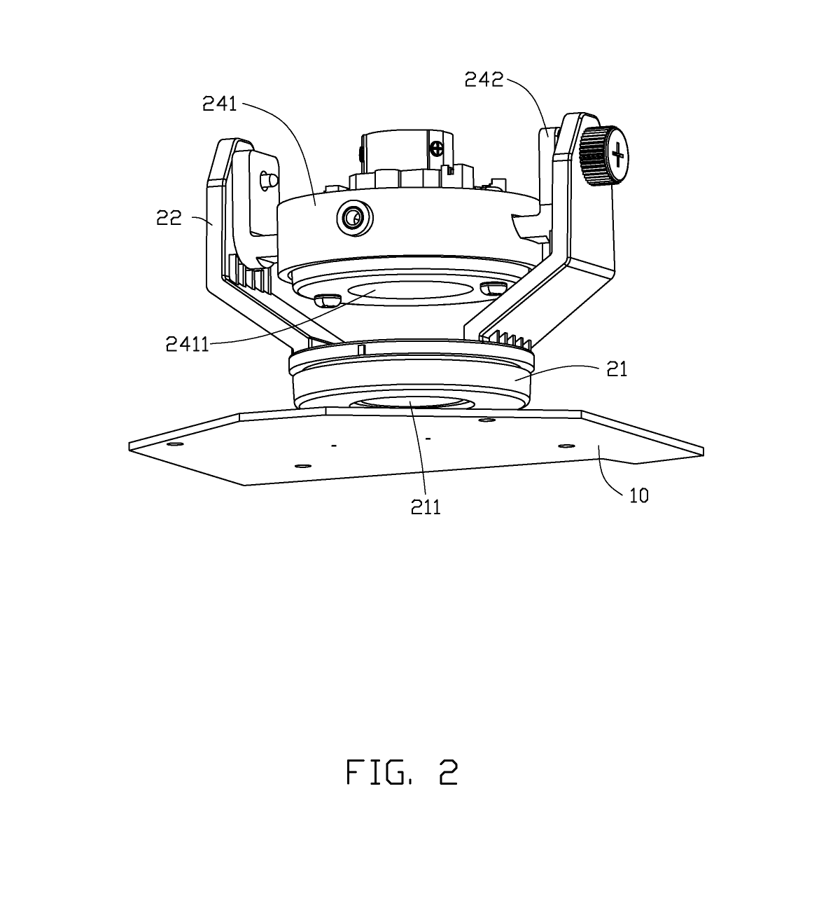

FIGS. 1 and 2 show an exemplary embodiment of a camera. The camera comprises a first bracket 20, a second bracket 24, a shield member 30, and a photosensitive element 40.

The first bracket 20 comprises a base 21, and two opposite connection arms 22 extending from the base 21. The base 21 defines a circular through hole 211.

The second bracket 24 is located between the connection arms 22. The second bracket 24 comprises a mounting portion 241 aligning with the base 21, and two opposite L-shaped pivot portions 242 extending from the mounting portion 241. The pivot portions 242 are pivotally connected to the connection arms 22. The mounting portion 241 defines a through slot 2411 in a side of the mounting portion 241 facing the base 21.

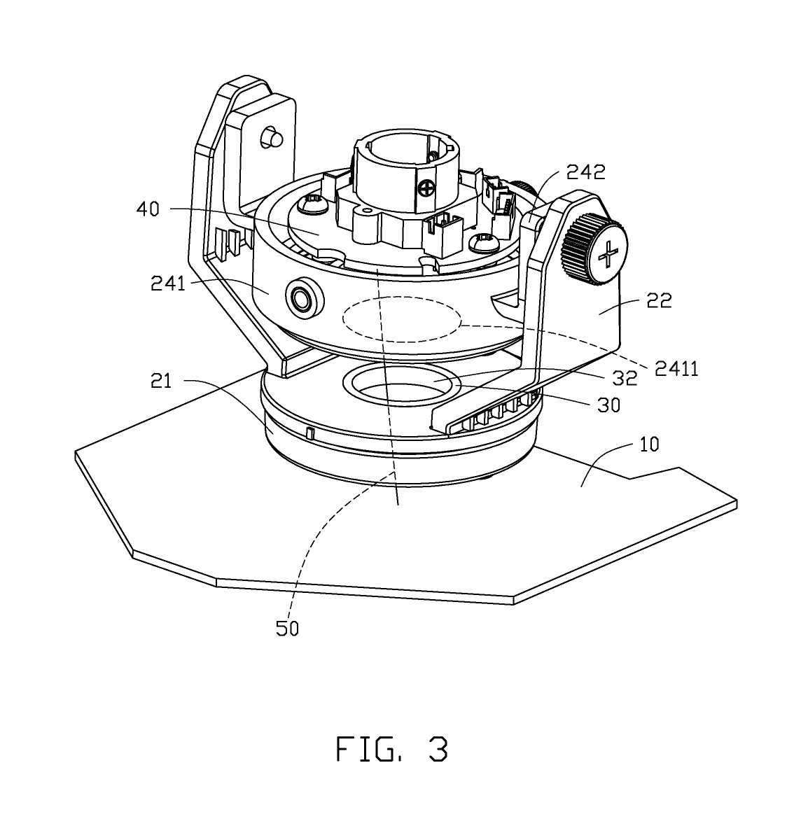

FIGS. 1 and 3 show that the shield member 30 is annular. The shield member 30 bounds an inner hole 32, and is made of material that can shield electromagnetic interference, such as ferrite. The shield member 30 is received in the through hole 211, and is fastened to the base 21.

The photosensitive element 40 is mounted in the mounting portion 241, and is electrically connected to a circuit board 10 by a cable 50, wherein the cable 50 extends through the through slot 2411 and the inner hole 32 of the shield member 30. The shield member 30 is made of material that shields electromagnetic interference, so that electromagnetic interference generated by the cable 50 is shielded.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A camera, comprising:
a first bracket comprising a base, the base defining a through hole;
a second bracket pivotally connected to the first bracket;
a shield member made of material that shields electromagnetic interference, the shield member received in the through hole and defining an inner hole;
a photosensitive element mounted to the second bracket; and
a cable electrically connected to the photosensitive element and extending through the inner hole.

2. The camera of claim 1, wherein the photosensitive element is made of ferrite.

3. The camera of claim 1, wherein the shield member is annular.

4. The camera of claim 1, wherein the second bracket comprises a mounting portion aligning with the base, the photosensitive element is received in the mounting portion, the mounting portion defines a through slot, the cable extends through the through slot.

5. The camera of claim 4, wherein the first bracket further comprises two opposite connection arms extending from the base, the second bracket further comprises two opposite pivot portions extending from the mounting portion, the pivot portions are pivotally connected to the connection arms.
